(19) United States
(12) Patent Application Publication
(10) Pub. No.: US 2026/0068798 A1
(43) Pub. Date: Mar. 12, 2026

(54) HYDRAULIC VALVE UNIT AND WORK MACHINE USING THE HYDRAULIC VALVE UNIT

(71) Applicant: KUBOTA CORPORATION, Osaka (JP)

(72) Inventor: Yohei HAMASAKI, Osaka (JP)

(73) Assignee: KUBOTA CORPORATION, Osaka (JP)

(21) Appl. No.: 19/129,093

(22) PCT Filed: Aug. 25, 2023
(86) PCT No.: PCT/JP2023/030712

§ 371 Date: May 12, 2025

(30) Foreign Application Priority Data
Dec. 22, 2022 (JP) 2022-205589

(51) Int. Cl. A01B 63/102; F16K 3/26; F16K 3/32; F16K 31/06

(52) U.S. Cl. CPC A01B 63/102; F16K 3/26; F16K 3/32; F16K 31/0668

(57) ABSTRACT

Provided is, as an operating mechanism for adjusting a biasing spring from outside a valve block, a mechanism that achieves stable flow rate adjustment while avoiding a structure that generates backlash. The operating mechanism includes: a spool 40a configured to adjust a flow rate of an oil passage disposed in a valve block 30; a solenoid 5 configured to move the spool 40a; a biasing spring 50 biasing the spool 40a in such a direction as to return the spool 40a to an initial position thereof, at least one initial pressure adjustment mechanism 6 configured to adjust a biasing force of the biasing spring 50. The at least one initial pressure adjustment mechanism 6 includes: a spring bearing member 51; an operating body 60 including an operation input portion 61 operable from outside the valve block 30 and an operation output portion 62 located inside the valve block 30 and in contact with the spring bearing member 51, and the at least one initial pressure adjustment mechanism 6 is configured to adjust the biasing force in response to the operation input portion 61 being operated to move the spring bearing member 51 in first directions in which the spool moves.

### TECHNICAL FIELD

The present invention relates to a hydraulic valve unit including a solenoid that operates a spool and a biasing spring that biases the spool in a direction opposite to the operating direction of the solenoid to return the spool to its initial position, and to a work machine using the hydraulic valve unit.

### BACKGROUND ART

In the hydraulic valve unit for the above-mentioned work machine, the spool is assembled into the valve block after the biasing force of the biasing spring has been adjusted to obtain an appropriate flow rate corresponding to the control current of the solenoid. In a spool associated with this solenoid, the adjustment of the initial pressure by the biasing spring is generally performed simultaneously with the installation of the solenoid, the spool, and the biasing spring into the valve block (for example, see Patent Document 1).

### PRIOR ART DOCUMENT

### Patent Document

Patent Document 1: JP 2010-158233a

### DISCLOSURE OF THE INVENTION

### Problem to be Solved by the Invention

With such a structure, if it becomes necessary to change the initial pressure that has already been set, the entire valve block must be disassembled, resulting in significant effort and time loss in assembly, adjustment, and other procedures.

In order to solve such a problem, a structure has conventionally been proposed in which the initial pressure of the biasing spring can be adjusted from the outside, as shown in FIG. 10, for example.

In this structure, a spring bearing member that receives and supports one end of the biasing spring is disposed inside the valve block, and a worm wheel portion is formed on the outer circumference of the spring bearing member 53. One end of a worm 66, which meshes with a worm wheel 67, is exposed to the outside of the valve block, thereby allowing the worm wheel 67 to be operated from the outside of the valve block via the worm 66. The spring bearing member 53 is supported at its inner circumference by the valve block on a threaded portion around the axis of the spool so that the spring bearing member 53 is movable in the axial direction of the spool.

However, in the above-mentioned structure using the worm 66 and the worm wheel 67, backlash inevitably exists between the worm 66 and the worm wheel 67. For this reason, when the worm wheel 67 moves by the amount of backlash due to a change in the jet pressure acting on the worm wheel 67, the controlled flow rate from the spool may momentarily become unstable. In other words, when the worm wheel 67 moves by an amount equal to the backlash caused by a change in the jet pressure acting on the worm wheel 67, at the point in time when the backlash occurs, the relationship between the current value applied to the solenoid and the flow rate corresponding to that current value may be temporarily disrupted, as shown in the graph in FIG. 11.

Therefore, in a structure with backlash, there is room for improvement in the above respects. In addition, such a structure is complicated, and there is room for improvement in terms of improving maintainability and reducing costs.

The present invention aims to provide, as an operating mechanism for adjusting the biasing spring from outside the valve block, a mechanism that achieves stable flow rate adjustment while avoiding a structure that generates backlash.

### Means for Solving Problem

A hydraulic valve unit according to the present invention includes:
a valve block;
an oil passage disposed in the valve block;
a spool configured to adjust a flow rate of hydraulic oil flowing through the oil passage;
a solenoid configured to move the spool in such a direction as to open and close the oil passage in response to a control current applied to the solenoid;
a biasing spring biasing the spool in such a direction as to return the spool to an initial position thereof; and
at least one initial pressure adjustment mechanism configured to adjust a biasing force of the biasing spring,
wherein the initial pressure adjustment mechanism includes:
a spring bearing member configured to receive the biasing force of the biasing spring;
an operating body including an operation input portion operable from outside the valve block and an operation output portion located inside the valve block and in contact with the spring bearing member, and
the at least one initial pressure adjustment mechanism being configured to adjust the biasing force in response to the operation input portion being operated to move the spring bearing in first directions in which the spool moves.

With the above configuration, the risk of the spring bearing member rattling due to fluctuations in the jet pressure in the oil passage is minimal, and stable flow rate adjustment can be easily performed from outside the valve block. Also, the configuration of the operating body itself has the advantage of being simple and easy to configure, as there is no need to adopt worms or worm wheels, which are structurally complex and require high machining and assembly precision.

In one preferred embodiment of the present invention,
the valve block includes an operating body mounting hole in which the operating body is mountable in such a manner as to be movable forward and backward in directions oblique to the moving direction of the spool, and
the spring bearing member moves in a direction along the moving direction of the spool in response to the operating body being moved in the forward and backward direction.

According to this means, the operating body moves in a direction oblique to the moving direction of the spring bearing member.

Therefore, even though the movement of the operating body itself is linear, the spring bearing member can be moved smoothly in a direction to increase or decrease the biasing force of the biasing spring by a component force in the moving direction of the operating body. This makes it easy to simplify the mechanism for transmitting the movement of the operating body to the spring bearing member. It is also easy to improve the accuracy of adjusting the biasing spring force by increasing the ratio of the operation amount of the operating body to the movement amount of the spring bearing member.

In one preferred embodiment of the present invention,
the spring bearing member includes a tubular portion fitted around the biasing spring outward of the spool, and an contact surface that is flange-shaped and protrudes radially outward from the tubular portion, and
the operating body is disposed so that the operation output portion is in contact with the contact surface.

According to this means, it is easier to ensure a wider arrangement area for the operating body radially outward from the tubular portion within the valve block, compared to a case in which the moving direction of the operating body is normal to the tubular portion. This makes it easy to set the moving distance of the operating body long, and to increase the ratio of the operation amount of the operating body to the movement amount of the spring bearing member to improve the accuracy of adjustment of the biasing spring force.

In one preferred embodiment of the present invention,
the valve block includes a first port disposed at an upstream portion of the oil passage, a second port disposed at a downstream portion of the oil passage, and a guide tube configured to guide hydraulic oil flowing in from the first port towards the second port, and
the guide tube is fixed to the valve block at a position where the guide tube fits over the spring bearing member.

According to this means, even if the pressure of the return oil from the output port is high and the return oil is ejected towards the spring bearing member, the guide tube is disposed upstream of the spring bearing member. As a result, the ejection pressure of the return oil can be received by the guide tube, which reduces the risk of a sudden ejection pressure acting on the spring bearing member. This makes it easy to minimize the risk of the biasing spring being affected by rattling of the spring bearing member.

In one preferred embodiment of the present invention,
in the operating body, the operation input portion is disposed at a first one end portion of the operation section and the operation output portion is disposed at a second end of the operation section, and the operation section includes a male threaded portion between the operation input portion and the operation output portion, and
the operating body mounting hole has a female threaded portion configured to threadedly receive the male threaded portion, and the spring bearing member moves in a direction along the movement direction of the spool in response to a change in a screwing amount by which the operating body is screwed into the operating body mounting hole.

According to this means, the position of the spring bearing member can be adjusted with the use of the operating body itself, which can be operated from outside the valve block. Therefore, the initial pressure adjustment mechanism can be easily formed with a simple structure using a single member, compared to a complex structure using a worm and worm wheel.

In one preferred embodiment of the present invention,
the operation section further includes: an outer circumferential threaded portion for preventing rotation of the operation section is formed on an outer circumference of the one end portion, separate from the operation input portion, and a locking nut mounted on the circumferential threaded portion and operable from outside the valve block.

According to this means, the male threaded portion and outer circumferential threaded portion disposed on the operating body itself can be used in conjunction with the female threaded portion and locking nut disposed in the operating body mounting hole to form a locking mechanism similar to a double nut, thereby simplifying the structure by sharing parts.

In one preferred embodiment of the present invention,
the valve block includes:
a pump port, a tank port, and an output port;
an output oil passage extending from the pump port to the output port;
a return oil passage extending from the output port to the tank port;
a first configured to adjust a flow rate of hydraulic oil flowing through the output oil passage;
a second configured to adjust a flow rate of hydraulic oil flowing through the return oil passage;
a first solenoid configured to, based on a control current applied to the first solenoid, operate the first spool in such a direction as to open and close the output oil passage;
a second solenoid configured to, based on a control current applied to the second solenoid, operate the second spool in such a direction as to open and close the return oil passage;
a first biasing spring biasing the first spool in such a direction as to return the first spool to an initial position thereof, and
a second biasing spring biasing the second spool in such a direction as to return the second spool to an initial position thereof, and
the at least one initial pressure adjustment mechanism is provided for at least one of the first biasing spring and the second biasing spring.

According to the present invention, an initial pressure adjustment mechanism that changes the setting of the biasing force of the biasing spring is provided for at least one of the first biasing spring and the second biasing spring, and the biasing force of each biasing spring can be operated from outside the valve block.

With the above configuration, the risk of the spring bearing member rattling due to fluctuations in the jet pressure in the oil passage is minimal, and stable flow rate adjustment can be easily performed from outside the valve block. Also, the configuration of the operating body itself has the advantage of being simple and easy to configure, as there is no need to adopt worms or worm wheels, which are structurally complex and require high machining and assembly precision.

In one preferred embodiment of the present invention,
the contact surface is a flat surface that is substantially orthogonal to the moving direction of the spool, and
the operation output portion is in contact with a portion of the contact surface which portion changes in response to the operating body being moved in the direction in which the operating body is movable forward and backward.

This means also makes it possible to move the operating body in a direction to increase or decrease the biasing force of the biasing spring. This makes it easy to simplify the mechanism for transmitting the movement of the operating body to the spring bearing member.

In one preferred embodiment of the present invention,
the above valve unit is disposed in a work machine.

According to this means, it is possible to obtain a valve unit that is suitable for controlling the operation of devices disposed in a work machine.

### BRIEF DESCRIPTION OF THE DRAWINGS

FIG. 1 is an overall right side view of a tractor.

FIG. 2 is a front view showing a portion in which a hydraulic mechanism for lifting and lowering and a valve unit are disposed.

FIG. 3 is a hydraulic circuit diagram showing a configuration of the hydraulic mechanism for lifting and lowering.

FIG. 4 is a cross-sectional view in an up-down direction of a valve block of the valve unit taken along a left right direction.

FIG. 5 is a cross-sectional view taken along a line V-V in FIG. 2.

FIG. 6 is a cross-sectional view taken along a line VI-VI in FIG. 2.

FIG. 7 is a cross-sectional view taken along a line VII-VII in FIG. 2.

FIG. 8 is a cross-sectional view taken along a line VIII-VIII in FIG. 2.

FIG. 9 is an exploded perspective view showing an operating body and a spring bearing member.

FIG. 10 is a cross-sectional view of a lowered side of a conventional valve unit.

FIG. 11 is a graph showing a relationship between a current value and a flow rate of the conventional valve unit.

### BEST MODE FOR CARRYING OUT THE INVENTION

Hereinafter, examples of embodiments of a hydraulic valve unit for work machines according to the present invention will be described with reference to the drawings.

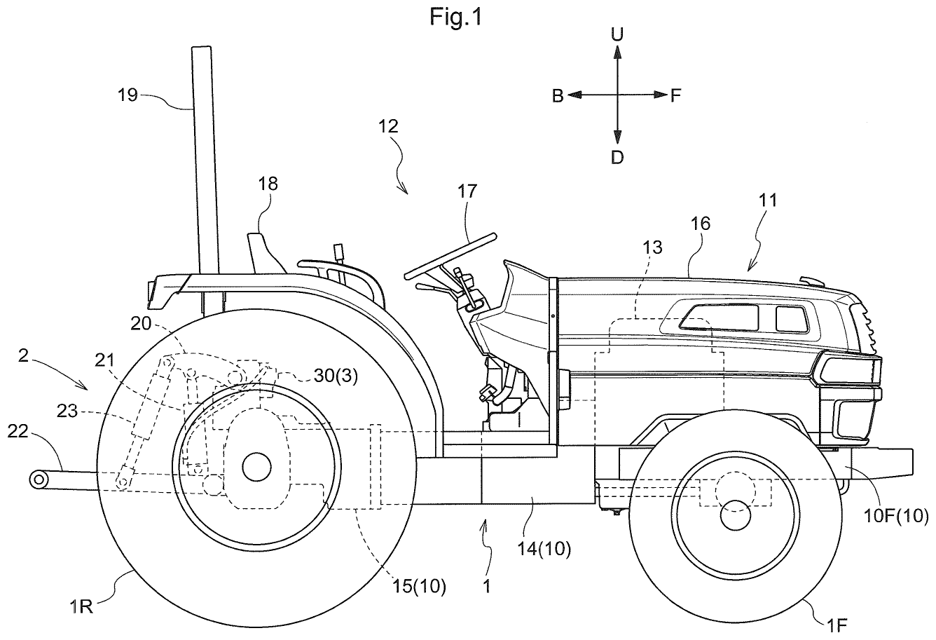

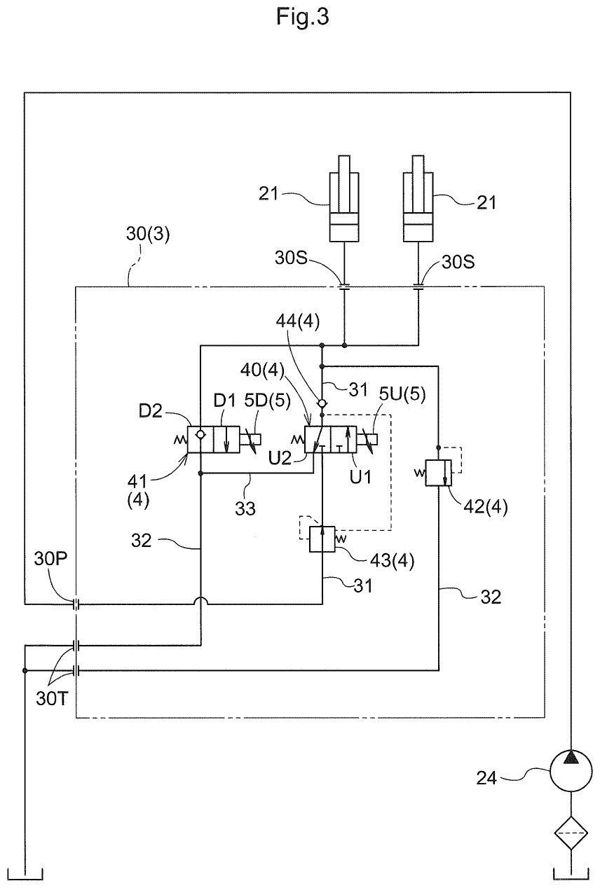

In the description of the embodiments, the front-rear direction and the left-right direction are described as follows, unless otherwise specified. That is, when a tractor, which is an example of a work machine to which the present invention is applied, is traveling, the forward travel direction (see an arrow F in FIG. 1) is “front”, the rearward travel direction (see an arrow B in FIG. 1) is “rear”, the direction corresponding to the right side based on the forward position in the front-rear direction (see an arrow R in FIG. 3) is “right”, and similarly, the direction corresponding to the left side (see an arrow L in FIG. 3) is “left”. Also, the arrow U in the figure indicates the “up” direction, and the arrow D indicates the “down” direction.

### Overall Configuration

As shown in FIG. 1, the tractor illustrated in the present embodiment has a travel body 1 in which a prime mover unit 11 is disposed in the front half of body frames 10 and a driver's section 12 is disposed in the rear half of the body frames 10. Front wheels 1F are disposed on the left and right of the prime mover unit as steerable wheels that are drivable, and rear wheels 1R are disposed on the left and right of the driver's section 12 as drive wheels that are not steerable and are drivable. The travel body 1 is configured as a self-propelled four-wheel drive type with the front wheels 1F and the rear wheels 1R.

A water-cooled diesel engine (hereinafter simply referred to as an engine) 13 is coupled to a front frame section 10F included in the body frames 10. A clutch housing 14 is coupled to a lower rear portion of the engine 13. A transmission case 15 is coupled to a rear portion of the clutch housing 14 with an intermediate frame section interposed therebetween. In this way, the body frames 10 of the tractor, including the front frame section 10F, the engine 13, the clutch housing 14, and the transmission case 15, is formed as a monocoque structure over almost the entire range in the front-rear direction.

In the prime mover unit 11, the engine 13 and so on are disposed in an engine room defined by a bonnet 16. In the driver's section 12, a steering wheel 17 for steering the front wheels, a driver's seat 18, and so on are disposed. A ROPS 19, which is gate-shaped when viewed from the front, stands upright from a rear section included in the body frames 10 and straddles a rear portion of the driver's seat 18.

Power for driving the front wheels is transmitted from the inside of the transmission case 15 to the left and right front wheels 1F via a front wheel transmission system (not shown) that extends to the left and right front wheels 1F. Power for driving the rear wheels is transmitted from the inside of the transmission case 15 to the left and right rear wheels 1R via a rear wheel transmission system (not shown) that extends to the left and right rear wheels 1R.

As shown in FIG. 1, at a position rearward of the transmission case 15, a work device coupling mechanism 2 for coupling with, and lifting and lowering, a work device (not shown) such as a rotary tiller or a plow that is coupled to the rear portion of the tractor is provided.

The work device coupling mechanism 2 includes a pair of left and right lift arms 20, a pair of left and right lift cylinders 21 (equivalent to the extension and retraction cylinders) that drive the corresponding lift arms 20 to swing up and down, and a pair of left and right lower links 22 for coupling with a work device, which are coupled to the lower rear end portion of the transmission case 15 so as to be able to swing up and down.

The right lift arm 20 is coupled to the right lower link 22 of the left and right lower links 22 with an extendable rolling cylinder 23 interposed therebetween. The left lift arm 20 is coupled to the left lower link 22 of the left and right lower links 22 with a linkage rod (not shown) interposed therebetween.

The left and right lift cylinders 21 are single-acting hydraulic cylinders, and the rolling cylinder 23 is a double-acting hydraulic cylinder.

With the above-described structure, the flow of hydraulic oil to the left and right lift cylinders 21 can be switched to simultaneously extend and retract the left and right lift cylinders 21 in the same direction, thereby driving the work device to move up and down.

By switching the flow of hydraulic oil to the rolling cylinder 23 to drive the rolling cylinder 23 to extend and retract, the work device can be operated in a rolling motion.

The flow of hydraulic oil to the left and right lift cylinders 21 and the rolling cylinder 23 can be switched by the operation of a hydraulic valve unit 3. The operation of this hydraulic valve unit 3 is controlled by a control means provided as a control program in a control device (not shown) configured using a microcomputer.

### Hydraulic Valve Unit

The hydraulic valve unit 3 will be described.

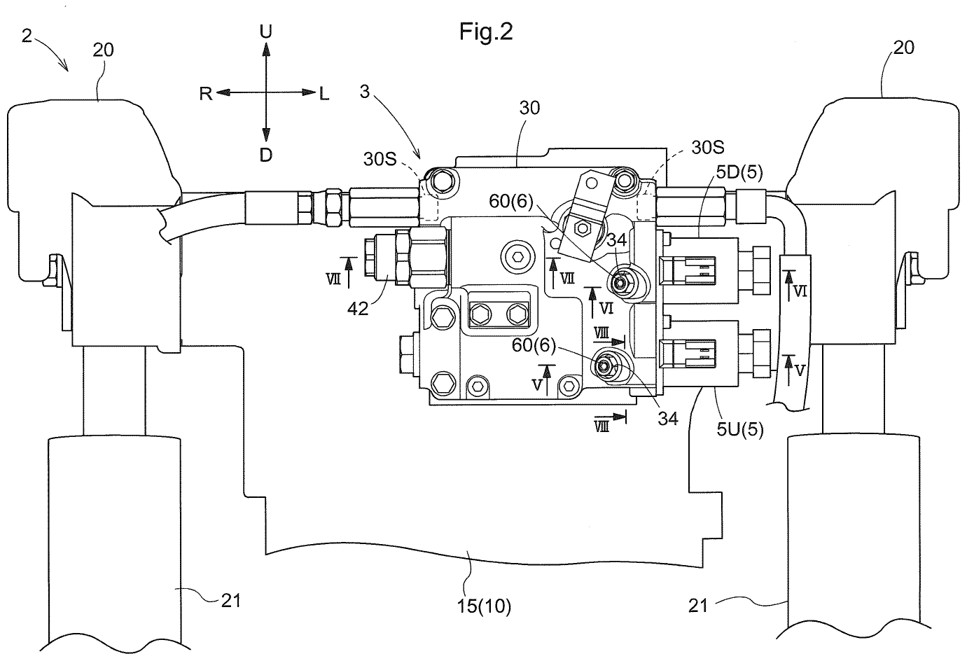

As shown in FIGS. 1 and 2, the hydraulic valve unit 3 is disposed on the upper surface of the transmission case 15 at a location corresponding to the space below the driver's seat 18 in the driver's section 12.

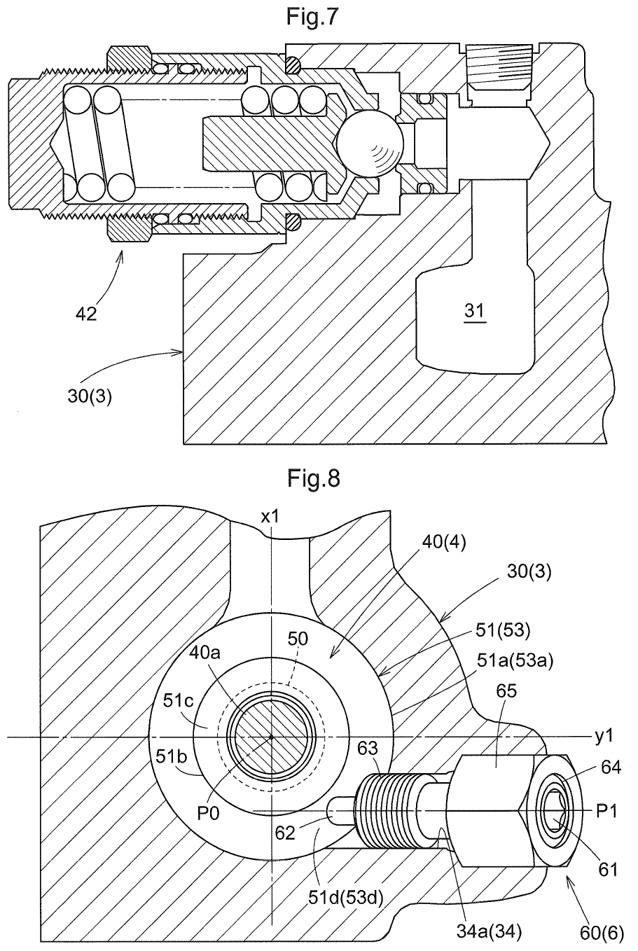

As shown in FIGS. 2 to 7, the hydraulic valve unit 3 includes a valve block 30 having oil passages formed therein, valves 4 that control the flow of hydraulic oil within the oil passages of the valve block 30, solenoids 5 that operate the valves 4, and initial pressure adjustment mechanisms 6 for adjusting the initial pressure of biasing springs 50 acting on the solenoids 5.

As shown in FIGS. 2 to 4, the valve block 30 includes a pump port 30P to which pressurized oil is supplied from the hydraulic pump 24, a tank port 30T (equivalent to the second port disposed downstream of the oil passage) for returning hydraulic oil from the valve block 30 to an external tank (although the transmission case 15 is used as the hydraulic oil tank in the present embodiment, a separate dedicated hydraulic oil tank may also be used), and output ports 30S (equivalent to a first port disposed upstream of the oil passage) that are continuous with the pair of lift cylinders 21 that lift and lower the lift arms 20.

The above-mentioned pump port 30P and output ports 30S are connected to each other via an output oil passage 31 formed in the valve block 30. Similarly, the output ports 30S and the tank ports 30T are connected to each other via return oil passages 32 formed in the valve block 30.

Furthermore, the valve block 30 includes a recirculating oil passage 33 that guides pressure oil supplied from the hydraulic pump 24 to the tank port 30T side when a lift operation valve 40, which will be described later, is operated to the lift stop state.

The valves 4, which control the flow of hydraulic oil within the oil passages of the valve block 30, include the lift operation valve 40 that can switch between a state where pressurized oil supplied from the hydraulic pump 24 is supplied to the lift cylinders 21 and a state where the supply is stopped.

The valves 4 also include a lowering operation valve 41 that can switch between a state where the return oil from the lift cylinders 21 is returned to the tank and a state where the lowering is stopped.

Furthermore, the valves 4 include a relief valve 42 that maintains the operating pressure of the output oil passage 31 at a predetermined pressure while the lift cylinders 21 are operating, an unloading valve 43 that releases pressurized oil supplied from the hydraulic pump 24 to the tank without load when the lift operation valve 40 is in the lift stop state, and a check valve 44 that is disposed in the output oil passage 31 to prevent backflow of pressurized oil from the lift cylinders 21 to the lift operation valve 40.

The lift operation valve 40 includes a first spool 40a located in the output oil passage 31. The lift operation valve 40 is a direct-acting solenoid valve configured to switch the position of the first spool 40a between a lifted position U1 and a lift stop position U2 shown in FIG. 3 by operating a lift solenoid 5U (equivalent to the first solenoid).

The lift operation valve 40 also includes a coil-shaped first biasing spring 50 that biases the first spool 40a in a direction opposite to the direction of operation by the lift solenoid 5U, to return the first spool 40a to its initial position. The first biasing spring 50 is mounted between a stopper 40b disposed on the outer circumference of the first spool 40a and a cylindrical spring bearing member 51 fitted onto the first spool 40a.

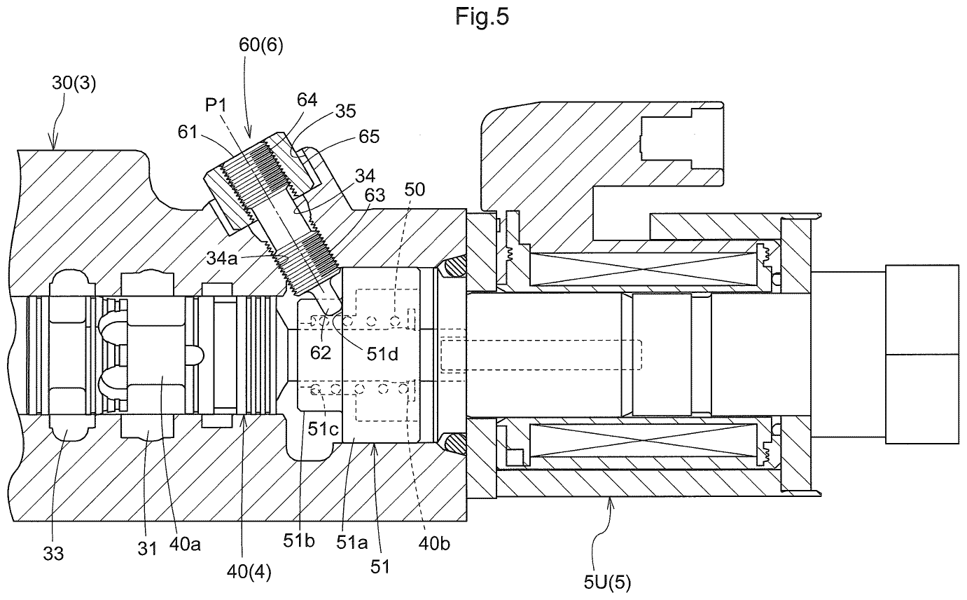

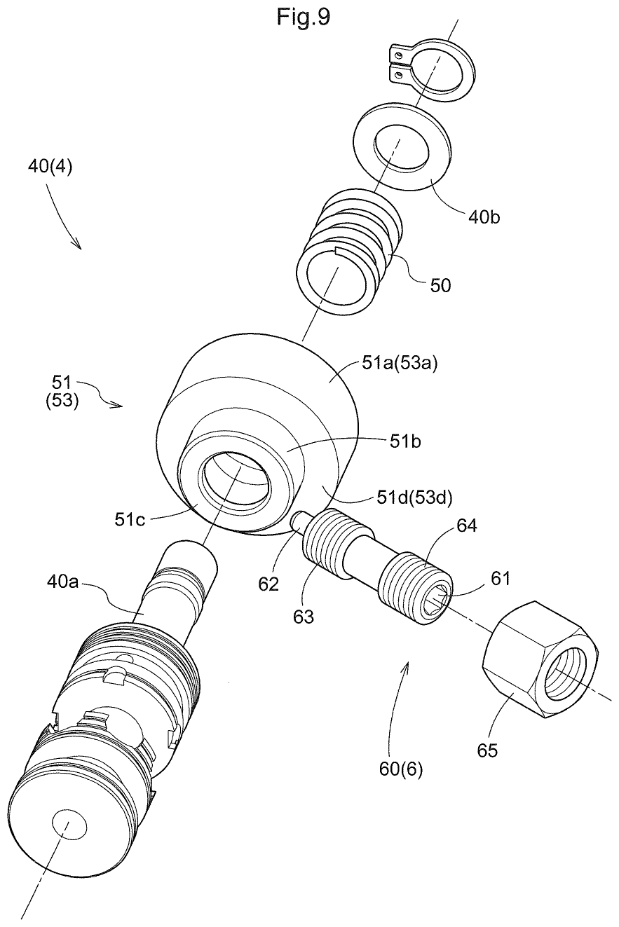

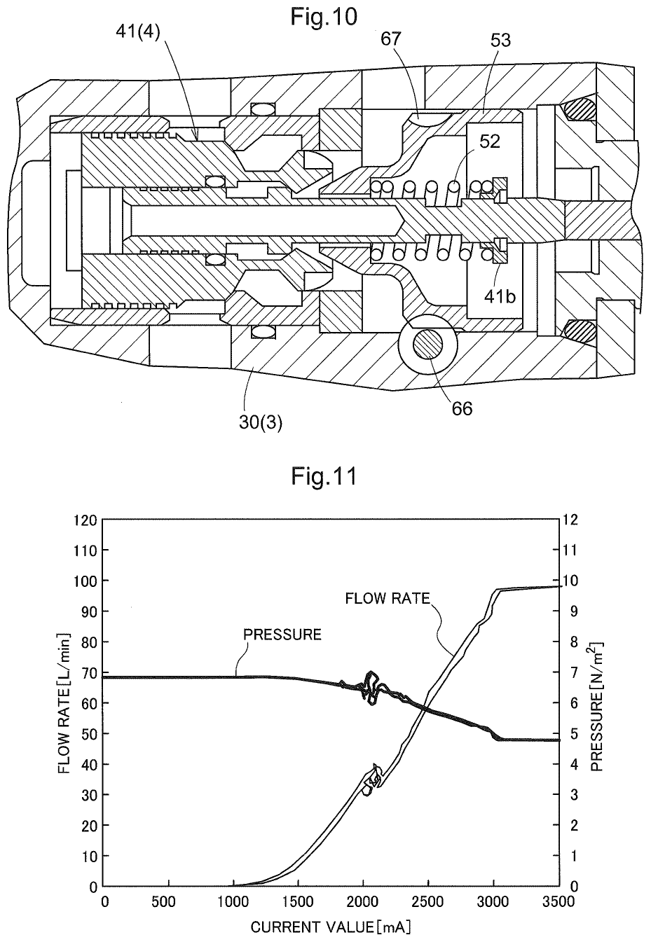

The cylindrical spring bearing member 51 fitted onto the first spool 40a is configured as a stepped cylindrical body that includes a large diameter tubular portion 51a and a small diameter tubular portion 51b, as shown in FIGS. 5 and 9.

The first biasing spring 50 is disposed between a bottom portion 51c of the small diameter tubular portion 51b and the stopper 40b, and is configured so that the initial pressure applied to the lift solenoid 5U can be changed by changing the distance between the bottom portion 51c and the stopper 40b with the use of the initial pressure adjustment mechanism 6 described later.

The lowering operation valve 41 includes a second spool 41a located in the return oil passage 32. The lowering operation valve 41 is a direct acting solenoid valve configured to switch the position of the second spool 41a between a lowered position D1 and a lowering stop position D2 shown in FIG. 3 by operating a lowering solenoid 5D (equivalent to the second solenoid).

The lowering operation valve 41 also includes a second biasing spring 52 in a coil shape that biases the second spool 41a in a direction opposite to the operating direction by the lowering solenoid 5D, and operates to return the second spool 41a to its initial position. The second biasing spring 52 is mounted between a stopper 41b disposed on the outer circumference of the second spool 41a and a cylindrical spring bearing member 53 fitted onto the second spool 41a.

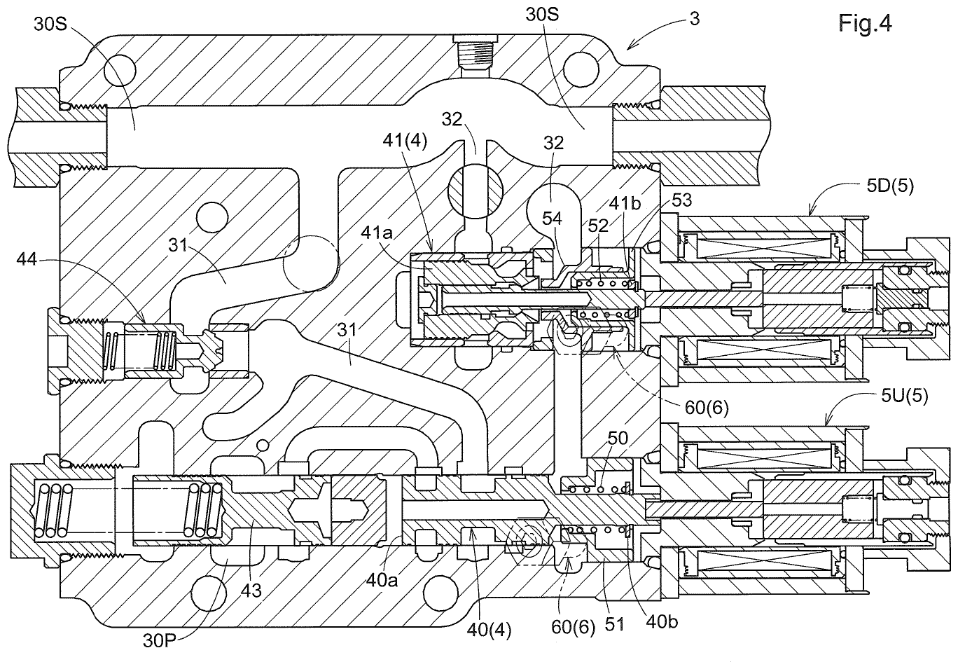

As shown in FIGS. 4, 6, and 8, the cylindrical spring bearing member 53 fitted onto the second spool 41a includes a flange portion 53b that extends in a collar shape at one end portion of a tubular portion 53a that fits over the second spool 41a, and a bottom portion 53c that extends radially inward of the tubular portion 53a at the other end portion.

The second biasing spring 52 is disposed between the bottom portion 53c of the tubular portion 53a and the stopper 41b, and is configured so that the initial pressure applied to the lowering solenoid 5D can be changed by changing the distance between the bottom portion 53c and the stopper 41b with the use of the initial pressure adjustment mechanism 6 described later.

### Initial Pressure Adjustment Mechanism

The initial pressure adjustment mechanisms 6 for changing the setting of the biasing forces of the first biasing spring 50 (equivalent to the biasing spring) and the second biasing spring 52 (equivalent to the biasing spring) will be described.

The initial pressure adjustment mechanisms 6 include the spring bearing members 51 and 53 that receive the reaction force of the first biasing spring 50 and the second biasing spring 52, and operating bodies 60 that change the positions of the spring bearing members 51 and 53 in a direction along the operating direction by the solenoids 5.

Of the spring bearing members 51 and 53, the spring bearing member 51, which receives the reaction force of the first biasing spring 50, includes an abutment surface 51d extending in a direction orthogonal to the biasing direction of the first biasing spring 50 at the step portion between the large diameter tubular portion 51a and the small diameter tubular portion 51b (equivalent to the tubular portion).

In a state where this abutment surface 51d abuts against the operating body 60, when a pushing operation is applied thereto with the use of the operating body 60, the spring bearing member 51 is moved in a direction compressing the first biasing spring 50, thereby changing the initial pressure applied by the solenoid 5.

When the position of the operating body 60 is moved away from the abutment surface 51d without applying a pushing operation to the operating body 60, the elastic restoring force of the first biasing spring 50 moves the spring bearing member 51 in a relaxing direction opposite to the compression direction of the first biasing spring 50, thereby changing the initial pressure applied by the solenoid 5.

Of the spring bearing members 51 and 53, the spring bearing member 53, which receives the reaction force of the second biasing spring 52, includes a flange portion 53b that extends in a collar shape at one end of the tubular portion 53a (corresponding to the tubular portion), and an abutment surface 53d in a direction orthogonal to the biasing direction of the second biasing spring 52.

In a state where this abutment surface 53d abuts against the operating body 60, when a pushing operation is applied thereto with the use of the operating body 60, the spring bearing member 53 is moved in a direction compressing the second biasing spring 52, thereby changing the initial pressure applied by the solenoid 5.

When the position of the operating body 60 is moved away from the abutment surface 53d without applying a pushing operation to the operating body 60, the elastic restoring force of the second biasing spring 52 moves the spring bearing member 53 in a relaxing direction opposite to the compression direction of the second biasing spring 52, thereby changing the initial pressure applied by the solenoid 5.

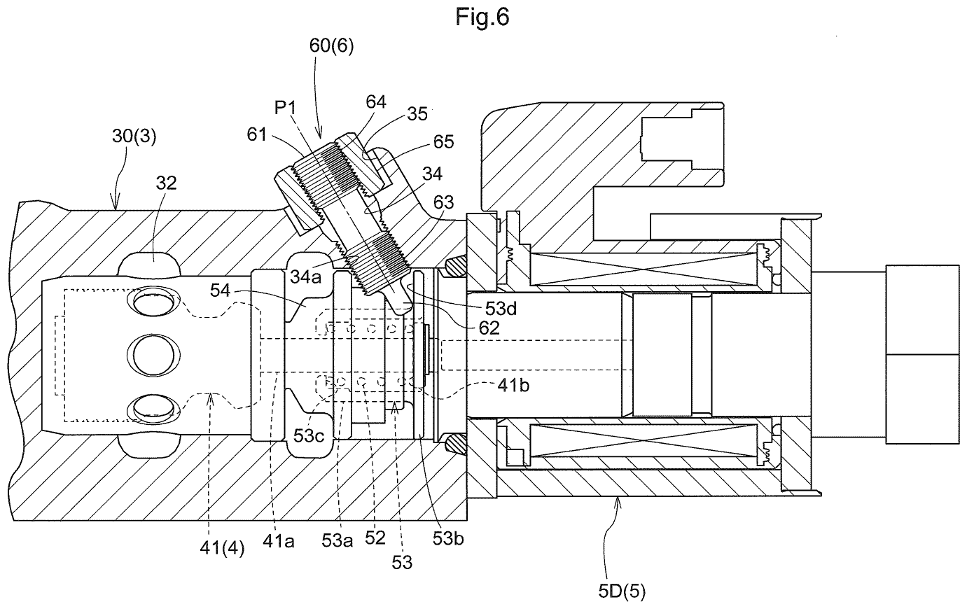

As shown in FIGS. 4 and 6, the return oil passage 32 in which the second spool 41a and the spring bearing member 53 are disposed includes a guide tube 54 that guides the return oil from the output port 30S towards the tank port 30T upstream of the spring bearing member 53. This guide tube 54 is formed in a shape having a conical guide surface that tapers towards the upstream side, and is fixed to the valve block 30, which forms the return oil passage 32, with the downstream side of the guide tube 54 fitted onto the spring bearing member 53.

This facilitates stable support of the spring bearing member 53 without causing any rattling and also allows the dynamic pressure of the return oil to be received by the guide tube 54, rather than having the ejection pressure of the return oil from the output port 30S act directly on the spring bearing member 53. As a result, even when the ejection pressure of the return oil from the output port 30S is large, rattling of the spring bearing member 53 is suppressed, and the biasing force of the second biasing spring 52 can be easily maintained in a stable manner.

### Operating Bodies

The operating bodies 60 of the initial pressure adjustment mechanisms 6 are configured as follows.

The operating bodies 60 each include an operation input portion 61 at one end and an operation output portion 62 at the other end, and a male threaded portion 63 is formed at the intermediate portion between the operation input portion 61 and the operation output portion 62.

Operating body mounting holes 34, into which the operating bodies 60 can be mounted, are formed in the valve block 30, and female threaded portions 34a, which can be screwed onto male threaded portions 63 formed at the intermediate portions of the operating bodies 60, are formed inside the operating body mounting holes 34.

The operation input portion 61 has a hexagonal hole that can be operated from the upper end side of the operating body 60 with the use of a tool such as a hexagonal wrench. When the male threaded portion 63 formed at the intermediate portion is screwed into the female threaded portion 34a of the operating body mounting hole 34 and the operating body 60 is rotated, the operation input portion 61 abuts against the abutment surface 51d of the spring bearing member 51 that receives the reaction force of the first biasing spring 50, or the abutment surface 53d of the spring bearing member 53 that receives the reaction force of the second biasing spring 52, thereby allowing the biasing force of the first biasing spring 50 or the second biasing spring 52 to be adjusted.

Each of the above-described operating bodies 60 is mounted to the valve block 30 in an inclined position, with a central axis P1 thereof in the longitudinal direction inclined downward in FIGS. 5 and 6 towards the abutment surface 51d or 53d when viewed from the side.

As shown in FIG. 8, the point at which the operating body 60 abuts against the abutment surface 51d or 53d is not directly on the normal line y1 passing through a central axis PO of the first spool 40a or the second spool 41a, but is a point shifted laterally in a direction along another normal line x1 that is orthogonal to the normal line y1.

In other words, as shown in FIG. 8, the operating body 60 is disposed so that the central axis P1 in the longitudinal direction moves in a direction along a tangent to the circumferential surface of the small diameter tubular portion 51b or the tubular portion 53a, which are equivalent to the tubular portion, and abuts against the abutment surface 51d or 53d.

In this way, since the contact points with the abutment surfaces 51d and 53d are located at points laterally shifted from the points directly on the normal lines y1 passing through the central axes P0 to the points along the other normal lines x1 orthogonal to the normal lines y1, it becomes easier to ensure relatively wide (long) contact ranges with the abutment surfaces 51d and 53d.

As shown in FIGS. 8 and 9, an outer circumferential threaded portion 64 for preventing rotation is formed on the outer circumference of one end of each of the operating bodies 60, in addition to the operation input portion 61. A locking nut 65 that can be operated from outside the valve block 30 is mounted to this outer circumferential threaded portion 64.

The locking nut 65 is tightened and fixed against the bottom surface of a recess 35 formed in the upper surface of the valve block 30, thereby functioning as a double nut together with the threaded connection between the male threaded portion 63 and the female threaded portion 34a formed at the intermediate portion of the operating body 60. As a result, the locking nuts 65 and the threaded connection portions between the male threaded portions 63 formed at the intermediate portions and the female threaded portions 34a function as a locking mechanism in the structure for attaching the operating bodies 60 to the valve block 30.

### Other Embodiments

Hereinafter, other embodiments will be described. A plurality of embodiments among the other embodiments described below may be combined with each other and applied to the above-described embodiment unless a contradiction occurs. Note that the scope of the present invention is not limited to the contents of these embodiments.

(1) Although the above embodiment illustrates a structure including the lift operation valve 40 and the lowering operation valve 41 for lifting and lowering the lift cylinders 21 as the valves 4 disposed in the valve block 30, the present invention is not necessarily limited to this structure.

For example, the valves 4 are not limited to being provided for the lift cylinders 21 that lift and lower the lift arms 20, but may also be provided to operate a cylinder for operating another work device.

Also, although the above embodiment illustrates a structure in which two lift cylinders 21 are operated simultaneously, it may also be a structure in which one lift cylinder 21 or three or more lift cylinders 21 are operated simultaneously.

The other configurations may be the same as those of the above-described embodiment.

(2) Although the above embodiment illustrates a structure in which the transmission case 15 is used as the hydraulic oil tank, the present invention is not necessarily limited to this structure. A separate dedicated hydraulic oil tank may be used.

The other configurations may be the same as those of the above-described embodiment.

(3) Although the above embodiment illustrates a structure including the abutment surfaces 51d and 53d extending in directions orthogonal to the biasing directions of the biasing springs 50 and 52, the present invention is not necessarily limited to this structure.

For example, the abutment surfaces 51d and 53d may be slightly inclined with respect to the biasing directions of the biasing springs 50 and 52, or may be curved surfaces.

The other configurations may be the same as those of the above-described embodiment.

(4) Although the above embodiment illustrates a structure in which each operating body 60 moves in a direction along a tangent to the circumferential surface of the tubular portion at a position that is offset in a circumferential direction from the normal passing through the tube center of the tubular portion (the small diameter tubular portion 51b or the tubular portion 53a) to abut against the abutment surface 51d or 53d, the present invention is not necessarily limited to this structure.

For example, as shown in FIG. 6, each operating body 60 may be configured to move in the normal direction at a position aligned with the normal line y1 passing through the tube center of the tubular portion or with the other normal line x1 orthogonal to the normal line y1.

The other configurations may be the same as those of the above-described embodiment.

(5) Although the above embodiment illustrates a structure in which each operating body 60 is mounted on the valve block 30 in an inclined position, with the central axis P1 thereof in the longitudinal direction inclined downward towards the abutment surface 51d or 53d when viewed from the side, the present invention is not necessarily limited to this structure.

For example, each operating body 60 may have a structure in which the central axis P1 thereof in the longitudinal direction is arranged in a substantially parallel position along the longitudinal direction of the first spool 40a and the second spool 41a, and is operated along the longitudinal direction of the first spool 40a and the second spool 41a.

The other configurations may be the same as those of the above-described embodiment.

(6) Although the above embodiment illustrates a structure in which one operating body 60 is provided for one lift operation valve 40 or one lowering operation valve 41, the present invention is not necessarily limited to this structure.

For example, a structure in which two or more operating bodies 60 are provided for one lift operation valve 40 or one lowering operation valve 41 may be used.

The other configurations may be the same as those of the above-described embodiment.

(7) Although the above embodiment illustrates a structure in which the outer circumferential threaded portion 64 and the locking nut 65 are disposed on each operating body 60 as a mechanism for preventing rotation of the operating body 60, the present invention is not necessarily limited to this structure.

For example, a pin to prevent rotation may be inserted, or a cushion to prevent loosening may be used. Also, it is not necessarily required to provide a mechanism for preventing rotation.

The other configurations may be the same as those of the above-described embodiment.

(8) Although the above embodiment illustrates a configuration in which the initial pressure adjustment mechanisms 6 are provided for both the first biasing spring 50 and the second biasing spring 52, the present invention is not limited to this structure, and an initial pressure adjustment mechanism 6 may be provided for only one of them.

The other configurations may be the same as those of the above-described embodiment.

### Industrial Applicability

A hydraulic valve unit for work machines according to the present invention is applicable to various types of agricultural work machines other than tractors, such as ride-on rice transplanters and ride-on grass cutters, as well as watering machines, construction machines, earthmoving machines, and other types of work machines.

### DESCRIPTION OF REFERENCE SIGNS

5: Solenoid
5U: First Solenoid
5D: Second Solenoid
6: Initial Pressure Adjustment Mechanism
20: Lift Arm
21: Extension and Retraction Cylinder
30: Valve Block
30P: Pump Port
30S: Output Port (First Port)
30T: Tank Port (Second Port)
31: Output Oil Passage
32: Return Oil Passage
34: Operating Body Mounting Hole
34a: Female Threaded Portion
40a: First Spool
41a: Second Spool
50, 52: Biasing Spring
51, 53: Spring Bearing Member
51a, 53a: Tubular Portion
51d, 53d: Abutting Surface
60: Operating Body
61: Operation Input Portion
62: Operation Output Portion
63: Male Threaded Portion
64: Outer Circumferential Threaded Portion
65: Locking Nut

1. A hydraulic valve unit, comprising:
a valve block;
an oil passage disposed in the valve block;
a spool configured to adjust a flow rate of hydraulic oil flowing through the oil passage;
a solenoid configured to move the spool in such a direction as to open and close the oil passage in response to a control current applied to the solenoid;
a biasing spring biasing the spool in such a direction as to return the spool to an initial position thereof; and
at least one initial pressure adjustment mechanism configured to adjust a biasing force of the biasing spring,
wherein the at least one initial pressure adjustment mechanism includes:
a spring bearing configured to receive the biasing force of the biasing spring; and
an operating body including an operation input portion operable from outside the valve block and an operation output portion located inside the valve block and in contact with the spring bearing member, and
the at least one initial pressure adjustment mechanism being configured to adjust the biasing force in response to the operation input portion being operated to move the spring bearing in first directions in which the spool moves.

2. The hydraulic valve unit according to claim 1,
wherein the valve block includes an operating body mounting hole in which the operating body is mountable in such a manner as to be movable forward and backward in directions oblique to the moving direction of the spool, and
the spring bearing member moves in a direction along the moving direction of the spool in response to the operating body being moved in the direction in which the operating body is movable forward and backward.

3. The hydraulic valve unit according to claim 2,
wherein the spring bearing member includes a tubular portion fitted around the biasing spring outward of the spool, and an contact surface that is flange-shaped and protrudes radially outward from the tubular portion, and
the operating body is disposed so that the operation output portion is in contact with the contact surface.

4. The hydraulic valve unit according to any one of claims 1 to 3,
wherein the valve block includes a first port disposed at an upstream portion of the oil passage, a second port disposed at a downstream portion of the oil passage, and a guide tube configured to guide hydraulic oil flowing in from the first port towards the second port, and
the guide tube is fixed to the valve block at a position where the guide tube fits over the spring bearing member.

5. The hydraulic valve unit according to any one of claims 2 to 4,
wherein, in the operating body, the operation input portion is disposed at a first one end portion of the operation section, and the operation output portion is disposed at a second end of the operation section, and
the operation section includes a male threaded portion between the operation input portion and the operation output portion, and
the operating body mounting hole has a female threaded portion configured to threadedly receive the male threaded portion, and the spring bearing member moves in a direction along the movement direction of the spool in response to a change in a screwing amount by which the operating body is screwed into the operating body mounting hole.

6. The hydraulic valve unit according to claim 5,
wherein the operation section further includes:
an outer circumferential threaded portion for preventing rotation of the operation section is formed on an outer circumference of the one end portion, separate from the operation input portion, and
a locking nut mounted on the outer circumferential threaded portion and operable from outside the valve block.

7. The hydraulic valve unit according to any one of claims 1 to 6,
wherein the valve block includes:
a pump port, a tank port, and an output port;
an output oil passage extending from the pump port to the output port;
a return oil passage extending from the output port to the tank port;
a first spool configured to adjust a flow rate of hydraulic oil flowing through the output oil passage;
a second spool configured to adjust a flow rate of hydraulic oil flowing through the return oil passage;
a first solenoid configured to, based on a control current applied to the first solenoid, operate the first spool in such a direction as to open and close the output oil passage;
a second solenoid configured to, based on a control current applied to the second solenoid, operate the second spool in such a direction as to open and close the return oil passage;
a first biasing spring biasing the first spool in such a direction as to return the first spool to an initial position thereof; and
a second biasing spring biasing the second spool in such a direction as to return the second spool to an initial position thereof, and
the at least one initial pressure adjustment mechanism is provided for at least one of the first biasing spring and the second biasing spring.

8. The hydraulic valve unit according to any one of claims 3 to 7,
wherein the contact surface is a flat surface that is substantially orthogonal to the moving direction of the spool, and
the operation output portion is in contact with a portion of the contact surface which portion changes in response to the operating body being moved in the direction in which the operating body is movable forward and backward.

9. A work machine comprising the hydraulic valve unit according to any one of claims 1 to 8.
